(19) United States
(12) Patent Application Publication
(10) Pub. No.: US 2021/0333598 A1
(43) Pub. Date: Oct. 28, 2021

(54) ULTRA-NARROW FRAME DISPLAY PANEL AND MANUFACTURING METHOD THEREOF

(71) Applicant: Yanxi Ye, Shenzhen (CN)

(72) Inventor: Yanxi Ye, Shenzhen (CN)

(21) Appl. No.: 16/624,382

(22) PCT Filed: Nov. 8, 2019
(86) PCT No.: PCT/CN2019/116683

§ 371 Date: Dec. 19, 2019

(30) Foreign Application Priority Data
Sep. 25, 2019 (CN) 201910908312.5

(51) Int. Cl. G02F 1/1339; G02F 1/1333; G02F 1/1335

(52) U.S. Cl. CPC G02F 1/13394; G02F 1/133514; G02F 1/133308

(57) ABSTRACT

An ultra-narrow frame display panel includes a display area and a frame area surrounding the display area. The display panel includes an array substrate and a color filter substrate disposed corresponding to each other. A sealant and a retaining wall structure configured to limit the sealant are disposed between the array substrate and the color filter substrate in the frame area. The retaining wall structure is closely attached to the sealant.

### BACKGROUND OF INVENTION

### 1. Field of Invention

The present invention relates to a technical field of displays, and particularly to, an ultra-narrow bezel display panel and a manufacturing method thereof.

### 2. Related Art

Due to development of public displays in recent years, large-sized and splice-type liquid crystal display (LCD) screen markets continue to increase. Each single unit of display screens is required to be shaped with frames as narrow as possible for splicing of large-sized LCD screens because frame areas are ineffective display areas. When four or nine pieces of LCD displays are spliced together, there is a black strip at a middle of a combined LCD display. The smaller width of the frame is, the narrower the black strip is, and display performance of the LCD displays being spliced is better. At present, a narrowest size of industry's large-sized LCD screens can be reached is 0.5 millimeters (mm).

As shown in FIG. 1, width of frames of general LCD screens is more than 5 mm, which is 10 times that of a narrowest frame at present. For general LCD screens, a width of frame sealant coatings is generally greater than or equal to 1000 microns (um) because the frames are wide, and a retaining wall corresponding to a frame sealant is designed to be away from a border of the frame sealant at greater than 140 um. Because the frame sealant coatings are in association with factors of a positional accuracy and a width accuracy, a combined effect of the positional accuracy and the width accuracy of a sealant coating apparatus is about 140 um. Retaining walls are made of blue color resistance. FIG. 1 shows a center of a sealant coating. An accuracy of an offset of a sealant coating to the left or right is still within a retaining wall. A function of the retaining wall is more to prevent an offset of a frame sealant in a particular situation, so the retaining wall cannot work to improve a coating accuracy.

FIG. 2 shows a configuration of a conventional frame sealant coating. According to a requirement of 0.5 mm for a narrow frame, a width of a frame sealant drops to 300 um, and the 300 um width is a width limit of a current frame sealant coating. In order to narrow a frame, a border of a glass is processed through an edge grinding process, and an accuracy of an edge grinding apparatus is 50 um. In this manner, a retaining wall on a left side is spaced apart from a border of the glass at a distance of 50 um dropped from 400 um of a general configuration. In order to prevent the frame sealant from influencing a display area, a retaining wall on a right side needs to be 100 um away from a display area. Accordingly, an overall frame width is calculated to be 0.73 mm, which is obviously not able to reach 0.5 mm. If an accuracy of the frame sealant coating is not taken into account, a frame of 0.45 mm can be achieved, but a yield will be seriously affected. Alternatively, an accuracy of the frame sealant coating can be increased to 25 um, but is not likely be implemented by a current apparatus.

Therefore, it is imperative to provide a novel ultra-narrow frame display panel and a method of manufacturing the same to reduce a frame width, as well as improve security of a display area of a display panel.

### SUMMARY OF INVENTION

An object of the present invention is to provide an ultra-narrow frame display panel and a method of manufacturing the same. By disposing a retaining wall structure attached to a sealant, a border of the sealant can be limited, a precision and an accuracy of manufacturing an ultra-narrow frame display panel can be improved, and a frame width can be reduced, thereby improving security of a display area of the ultra-narrow frame display panel.

In order to achieve the above-mentioned object, the present invention provides an ultra-narrow frame display panel, comprising a display area and a frame area surrounding the display area; an array substrate and a color filter substrate disposed corresponding to the array substrate; wherein a sealant and a retaining wall structure configured to limit the sealant are disposed between the array substrate and the color filter substrate in the frame area, and the retaining wall structure is closely attached to the sealant.

Furthermore, the retaining wall structural comprises a first lower retaining wall disposed on a side of the array substrate adjacent to the color filter substrate and attached to a side of the sealant away from the display area; and a second lower retaining wall disposed on the side of the array substrate adjacent to the color filter substrate and attached to a side of the sealant adjacent to the display area.

Furthermore, the retaining wall structure further comprises a first upper retaining wall disposed on a side of the color filter substrate adjacent to the array substrate and attached to a side of the sealant away from the display area; and a second upper retaining wall disposed on the side of the color filter substrate adjacent to the array substrate and attached to a side of the sealant adjacent to the display area; wherein the first upper retaining wall and the first lower retaining wall are disposed corresponding to each other, and the second upper retaining wall and the second lower retaining wall are disposed corresponding to each other.

Furthermore, the frame area has a width of 0.5 millimeters (mm), and the sealant has a width of 300 microns (um).

Furthermore, the frame area comprises a left border and a right border, and the right border is defined as a dividing line between the frame area and the display area; wherein the sealant is spaced at a distance of 100-150 um from the right border, and the sealant is spaced at a distance of 50-100 um from the left border.

Furthermore, the first upper retaining wall is a red retaining wall, a green retaining wall, or a blue retaining wall; the second upper retaining wall is a red retaining wall, a green retaining wall, or a blue retaining wall; the first lower retaining wall is a red retaining wall, a green retaining wall, or a blue retaining wall; and the second lower retaining wall is a red retaining wall, a green retaining wall, or a blue retaining wall.

Furthermore, the first upper retaining wall has a color the same as that of the second upper retaining wall; and the first lower retaining wall has a color the same as that of the second lower retaining wall.

The present invention further provides a method of manufacturing an ultra-narrow frame display panel, comprising providing an array substrate and a color filter substrate, wherein the array substrate comprises a frame area and a display area, the frame area comprises a sealant area, and two sides of the sealant area each are provided with a first lower retaining wall and a second lower retaining wall; coating a sealant film configured with an upper width less than a lower width on the sealant area; press-fitting the array substrate and the color filter substrate; and forming, using ultraviolet to cure the sealant film in the sealant area, a sealant.

Furthermore, the method of manufacturing the ultra-narrow frame display panel further comprises forming a first upper retaining wall on the color filter substrate; and/or forming a second upper retaining wall on the color filter substrate.

Furthermore, the method of manufacturing the ultra-narrow frame display panel further comprises the first upper retaining wall and the first lower retaining wall disposed corresponding to each other, and/or the second upper retaining wall and the second lower retaining wall are disposed corresponding to each other.

The present invention provides the ultra-narrow frame display panel and the method of manufacturing the same. By disposing a newly added retaining wall structure attached to the sealant, borders of the sealant can be limited. The retaining structural wall generally includes four retaining walls disposed on the array substrate and the color filter substrate, respectively, and upper and lower retaining walls are disposed corresponding to each other. Because the retaining walls are fabricated through an exposure process using an exposure machine, a precision of fabrication is very high. As long as a width of the retaining wall structure 10 reaches a certain value, a structure of the ultra-narrow frame display panel of the present invention can be maintained even if an accuracy offset occurs.

### BRIEF DESCRIPTION OF DRAWINGS

To better illustrate embodiments or technical solutions in the prior art, a brief description of the drawings used in the embodiments or the prior art description will be given below. Obviously, the accompanying drawings in the following description merely show some embodiments of the present invention, and a person skilled in the art may still derive other drawings from these accompanying drawings without creative efforts.

FIG. 1 is a schematic structural view of a 5 mm frame of a conventional display panel.

FIG. 2 is a schematic structural view of a 0.5 mm narrow frame of a conventional display panel.

FIG. 3 is a schematic structural view of an ultra-narrow frame display panel of a first embodiment of the present invention.

FIG. 4 is another schematic structural view of an ultra-narrow frame display panel of the first embodiment of the present invention.

FIG. 5 is a schematic structural view showing a formation of an array substrate of the first embodiment of the present invention.

FIG. 6 is a schematic structural view showing an array substrate and a color filter substrate are laminated in accordance with the first embodiment of the present invention.

FIG. 7 is a schematic structural view showing an offset of an accuracy of a sealant of the first embodiment of the present invention.

FIG. 8 is a schematic structural view of an ultra-narrow frame display panel of a second embodiment of the present invention.

FIG. 9 is another schematic structural view of an ultra-narrow frame display panel of the second embodiment of the present invention.

FIG. 10 is a schematic structural view of an ultra-narrow frame display panel of a third embodiment of the present invention.

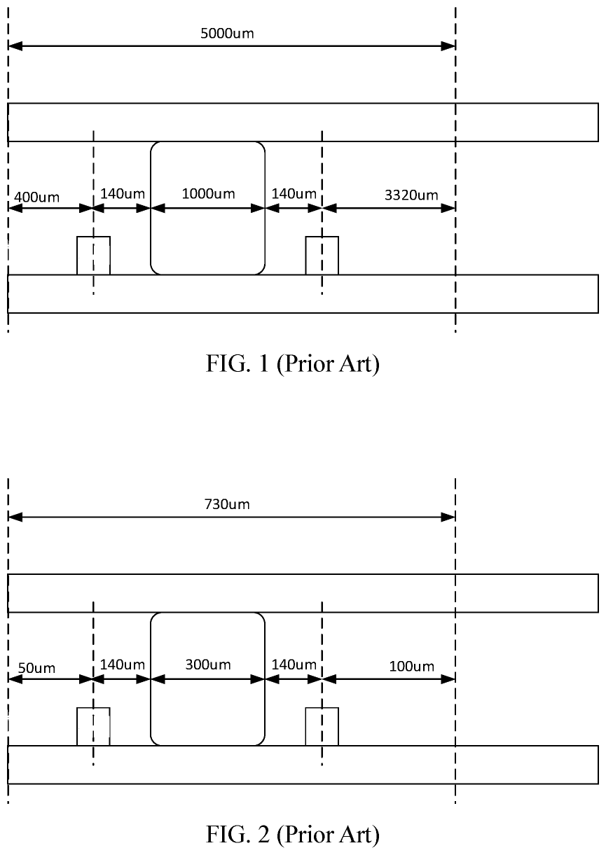

### DESCRIPTION OF PREFERRED EMBODIMENTS

The following embodiments are referring to the accompanying drawings for exemplifying specific implementable embodiments of the present invention. Directional terms described by the present invention, such as upper, lower, front, back, left, right, inner, outer, side, etc., are only directions by referring to the accompanying drawings, and thus the used directional terms are used to describe and understand the present invention, but the present invention is not limited thereto.

Embodiments of the present invention will be described in detail herein with reference to the drawings. The present invention may be embodied in many different forms, and the invention is not to be construed as being limited to the specific embodiments set forth herein. The embodiments of the present invention are provided to explain the practical application of the present invention so that those skilled in the art can understand various embodiments of the present invention and various modifications suitable for the particular intended application.

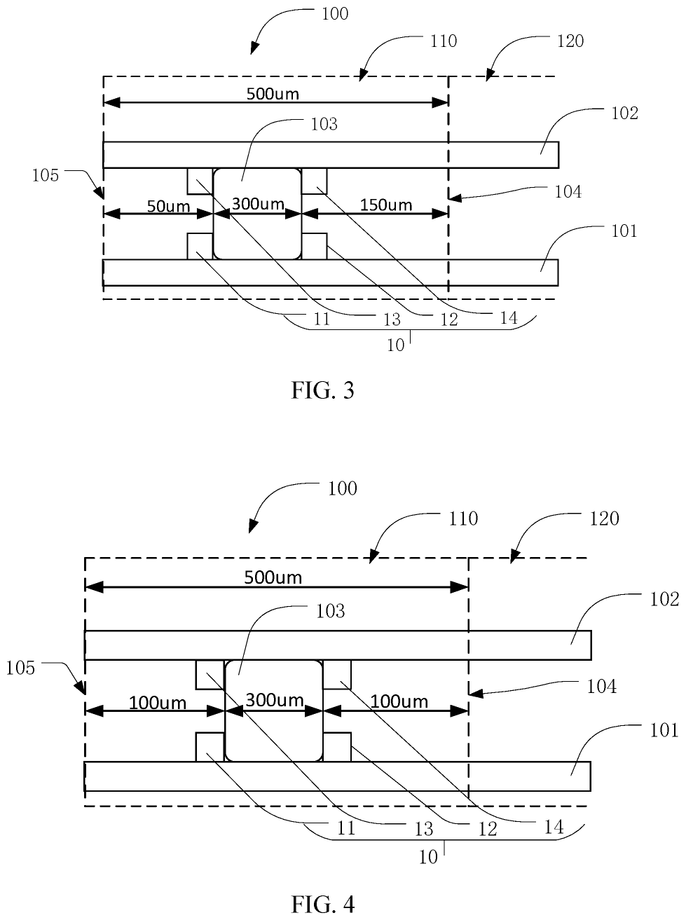

As shown in FIG. 3, a first embodiment of the present invention provides an ultra-narrow frame display panel 100, including a display area 120 and a frame area 110. The frame area 100 surrounds the display area 120. The display panel 100 includes an array substrate 101 and a color filter substrate 102 disposed corresponding to each other.

In the frame area 110, a sealant 103 and a retaining wall 10 configured to limit the sealant 103 are disposed between the array substrate 101 and the color filter substrate 102. The retaining wall structure 10 is attached to the sealant 103.

In this embodiment, the retaining wall structure 10 includes a first lower retaining wall 11, a second lower retaining wall 12, a first upper retaining wall 13, and a second upper retaining wall 14.

The first lower retaining wall 11 is disposed on a side of the array substrate 101 adjacent to the color filter substrate 102 and is attached to a side of the sealant 103 away from the display area 120.

The second lower retaining wall 12 is disposed on the side of the array substrate 101 adjacent to the color filter substrate 102 and is attached to a side of the sealant 103 adjacent to the display area 120.

The first upper retaining wall 13 is disposed on a side of the color filter substrate 102 adjacent to the array substrate 101 and is attached to a side of the sealant 103 away from the display area 120.

The second upper retaining wall 14 is disposed on the side of the color filter substrate 102 adjacent to the array substrate 101 and is attached to a side of the sealant 103 adjacent to the display area 120.

The first upper retaining wall 13 and the first lower retaining wall 11 are disposed corresponding to each other. The second upper retaining wall 14 and the second lower retaining wall 12 are disposed corresponding to each other.

The frame area 110 includes a left border 105 and a right border 104, and the right border 104 is defined as a dividing line between the frame area 110 and the display area 120.

The frame area has a width of 0.5 millimeters (500 um), and the sealant 103 has a width of 300 microns (um).

The sealant 103 is spaced apart from the right border 104 at a distance of 100-150 um, for example, such as 110 um, 120 um, 130 um, or 140 um. The sealant 103 is spaced apart from the left border 105 at a distance of 50-100 um, such as 60 um, 70 um, 80 um, or 90 um.

In this embodiment, a selection of a distance between the sealant 103 and the right boundary 104 must take into account a distance between the sealant 103 and the left boundary 105 to allow a sum of the above-mentioned two distances to be 200 um.

In this embodiment, the sealant 103 is spaced at a distance of 150 um from the right border 104, and the sealant 103 is spaced at a distance of 50 um from the left border 105. A distance between the sealant 103 and the right border 104 increases by 50 um comparing to an extreme limit of 100 um. In this manner, a risk of influence on the display area 120 is further reduced, and the 50 um space can also be used for improvement of a boundary process capability.

As shown in FIG. 4, the sealant 103 may also be spaced at a distance of 100 um from the right border 104, and the sealant 103 may also be spaced at a distance of 100 um from the left border 105. But such a configuration increases a risk of influence on the display area 120 compared to the configuration in FIG. 3.

The first upper retaining wall 13 is a red retaining wall, a green retaining wall, or a blue retaining wall; the second upper retaining wall 14 is a red retaining wall, a green retaining wall, or a blue retaining wall; the first lower retaining wall 11 is a red retaining wall, a green retaining wall, or a blue retaining wall; and the second lower retaining wall 12 is a red retaining wall, a green retaining wall, or a blue retaining wall.

The first upper retaining wall 13 and the second upper retaining wall 14 have a same color. The first lower retaining wall 11 and the second lower retaining wall have a same color.

The present invention further provides a method of manufacturing an ultra-narrow frame display panel 100. The method includes following steps S1-S5.

S1: providing an array substrate 101 and a color filter substrate 102, wherein the array substrate 101, as shown in FIG. 5 includes a frame area 110 and a display area 120, the frame area 110 includes a sealant area 230, and two sides of the sealant area 230 each are provided with a first lower retaining wall 11 and a second lower retaining wall 12.

S2: coating a sealant film 106 configured with an upper width less than a lower width on the sealant area 230. As shown in FIG. 5, the sealant film 106 has a thickness of 50 um, and is spaced at 125 um from the first lower retaining wall 11 and the second lower retaining wall 12, wherein an accuracy of a coating position is about ±120 um. In this manner, the first lower retaining wall 11 and the second lower retaining wall 12 will not be coated with the sealant film 106 when coating the sealant film 106.

S3: forming a first upper retaining wall 13 and a second upper retaining wall 14 on the color filter substrate 102. The first upper retaining wall 13 and the second upper retaining wall 14 are disposed corresponding to each other. The second upper retaining wall 14 and the second lower retaining wall 12 are disposed corresponding to each other.

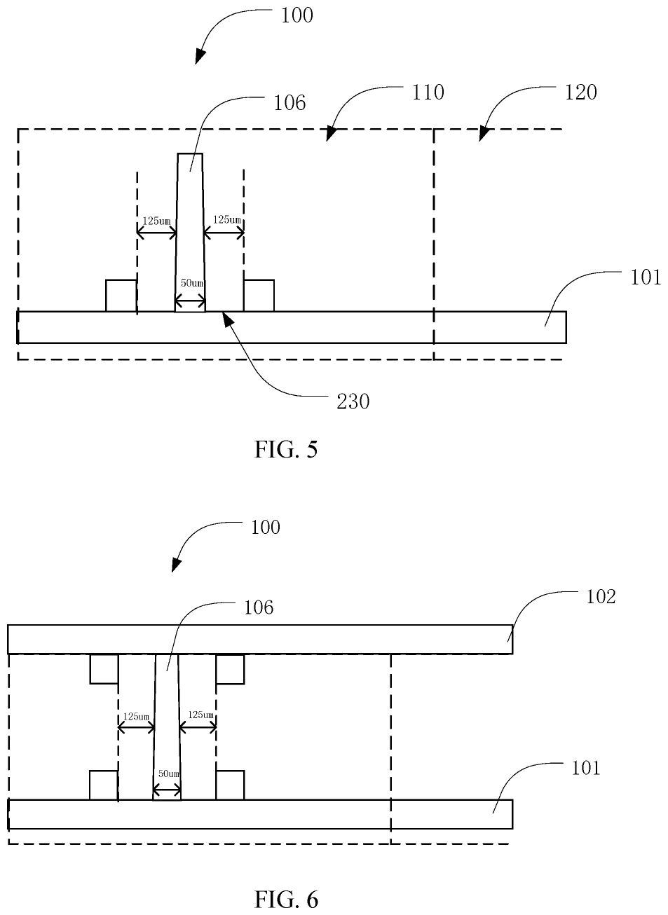

S4: as show in FIG. 6, the array substrate 101 and the color filter substrate 102 are cell-assembled by press-fitting.

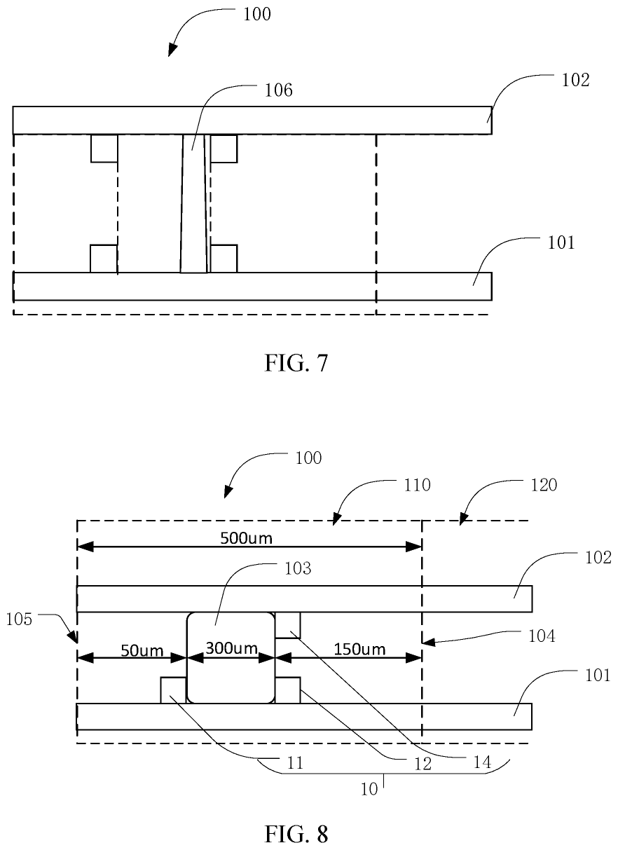

As shown in FIG. 7, assuming that a coating of the sealant film 106 is shifted to the right to an extreme limit, when the color filter substrate 102 is firstly in contact with the sealant film 106 during a process of assembling the array substrate 101 and the color filter substrate 102, due to the presence of the retaining wall structure 10, the sealant film 106 is compressed to flow to the left and is finally limited between the walls at two opposite sides of the sealant film 106.

S5: forming a sealant 103 using ultraviolet to cure the sealant area.

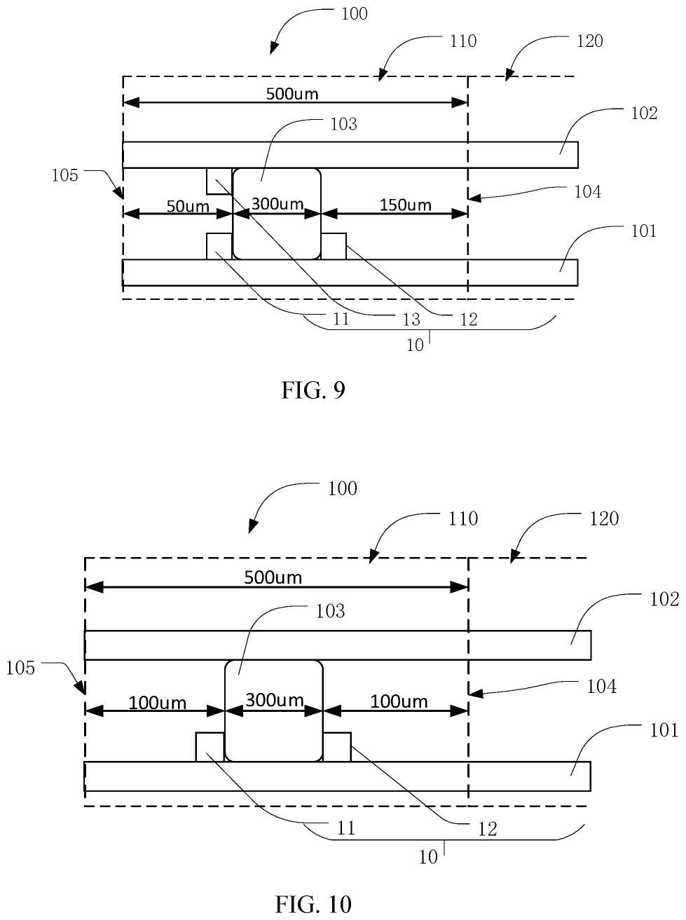

As shown in FIGS. 8 and 9, a second embodiment of the present invention further provides an ultra-narrow frame display panel 100. The second embodiment is different from the first embodiment in that one of upper retaining walls of the retaining wall structure 10 is eliminated in the second embodiment, and only a first upper retaining wall 13 or a second upper retaining wall 14 remains. For example, the retaining wall structure 10 as shown in FIG. 8 includes a first lower retaining wall 11, a second lower retaining wall 12, and the second upper retaining wall 14.

In the second embodiment as shown in FIG. 8, the first lower retaining wall 11 is disposed on a side of the array substrate 101 adjacent to the color filter substrate 102 and is attached to a side of the sealant 103 away from the display area.

In the second embodiment as shown in FIG. 8, the second lower retaining wall 12 is disposed on the side of the array substrate 101 adjacent to the color filter substrate 102 and is attached to a side of the sealant 103 adjacent to the display area.

In the second embodiment as shown in FIG. 8, the second upper retaining wall 14 and the second lower retaining wall 12 are disposed corresponding to each other.

In the second embodiment as shown in FIG. 9, the retaining wall structure 10 remains the first upper retaining wall 13, and the first upper retaining wall 13 and the first lower retaining wall 11 are disposed corresponding to each other.

As shown in FIG. 10, a third embodiment of the present invention further provides an ultra-narrow frame display panel 100. The third embodiment is different from the first embodiment in that the retaining wall structure 10 of the third embodiment includes a combination of a first lower retaining wall 11 and a second lower retaining wall 12, but not include a first upper retaining wall 13 and a second upper retaining wall 14.

In the third embodiment as shown in FIG. 10, the first lower retaining wall 11 is disposed on a side of the array substrate 101 adjacent to the color filter substrate 102 and is attached to a side of the sealant 103 away from the display area.

In the third embodiment as shown in FIG. 10, the second lower retaining wall 12 is disposed on the side of the array substrate 101 adjacent to the color filter substrate 102 and is attached to a side of the sealant 103 adjacent to the display area.

The present invention provides the ultra-narrow frame display panel 100 and the method of manufacturing the same. By disposing a newly added retaining wall structure 10 attached to the sealant 103, borders of the sealant 103 can be limited. The retaining structural wall 10 generally includes four retaining walls disposed on the array substrate 101 and the color filter substrate 102, respectively, and upper and lower retaining walls are disposed corresponding to each other. Because the retaining walls are fabricated through an exposure process using an exposure machine, a precision of fabrication is very high. As long as a width of the retaining wall structure 10 reaches a certain value, a structure of the ultra-narrow frame display panel of the present invention can be maintained even if an accuracy offset occurs. The sealant 103 of the present invention is spaced at 150 um from the display area, which increases by 50 um comparing to an extreme limit of 100 um. In this manner, a risk of influence on the display area 120 is further reduced, and the 50 um space can also be used for improvement of a boundary process capability.

The technical scope of the present invention is not limited to the contents of the description, and various modifications and changes can be made to the embodiments without departing from the technical idea of the present invention. It should be within the scope of the invention.

What is claimed is:

1. An ultra-narrow frame display panel, comprising:
a display area and a frame area surrounding the display area;
an array substrate and a color filter substrate disposed corresponding to each other;
wherein a sealant and a retaining wall structure configured to limit the sealant are disposed between the array substrate and the color filter substrate in the frame area, and the retaining wall structure is closely attached to the sealant.

2. The ultra-narrow frame display panel of claim 1, where the retaining wall structural comprises:
a first lower retaining wall disposed on a side of the array substrate adjacent to the color filter substrate and attached to a side of the sealant away from the display area; and
a second lower retaining wall disposed on the side of the array substrate adjacent to the color filter substrate and attached to a side of the sealant adjacent to the display area.

3. The ultra-narrow frame display panel of claim 2, wherein the retaining wall structure further comprises:
a first upper retaining wall disposed on a side of the color filter substrate adjacent to the array substrate and attached to a side of the sealant away from the display area; and
a second upper retaining wall disposed on the side of the color filter substrate adjacent to the array substrate and attached to a side of the sealant adjacent to the display area;
wherein the first upper retaining wall and the first lower retaining wall are disposed corresponding to each other, and the second upper retaining wall and the second lower retaining wall are disposed corresponding to each other.

4. The ultra-narrow frame display panel of claim 1, wherein the frame area has a width of 0.5 millimeters (mm), and the sealant has a width of 300 microns (um).

5. The ultra-narrow frame display panel of claim 1, wherein the frame area comprises a left border and a right border, and the right border is defined as a dividing line between the frame area and the display area; wherein the sealant is spaced at a distance of 100-150 um from the right border, and the sealant is spaced at a distance of 50-100 um from the left border.

6. The ultra-narrow frame display panel of claim 3, wherein the first upper retaining wall is a red retaining wall, a green retaining wall, or a blue retaining wall;
the second upper retaining wall is a red retaining wall, a green retaining wall, or a blue retaining wall;
the first lower retaining wall is a red retaining wall, a green retaining wall, or a blue retaining wall; and
the second lower retaining wall is a red retaining wall, a green retaining wall, or a blue retaining wall.

7. The ultra-narrow frame display panel of claim 3, wherein the first upper retaining wall has a color the same as that of the second upper retaining wall; and the first lower retaining wall has a color the same as that of the second lower retaining wall.

8. A method of manufacturing an ultra-narrow frame display panel, comprising:
providing an array substrate and a color filter substrate, wherein the array substrate comprises a frame area and a display area, the frame area comprises a sealant area, and two sides of the sealant area each are provided with a first lower retaining wall and a second lower retaining wall;
coating a sealant film configured with an upper width less than a lower width on the sealant area;
press-fitting the array substrate and the color filter substrate; and
forming, using ultraviolet to cure the sealant film in the sealant area, a sealant.

9. The method of manufacturing the ultra-narrow frame display panel of claim 8, further comprising:
forming a first upper retaining wall on the color filter substrate; and/or
forming a second upper retaining wall on the color filter substrate.

10. The method of manufacturing the ultra-narrow frame display panel of claim 9, wherein the first upper retaining wall and the first lower retaining wall are disposed corresponding to each other, and/or the second upper retaining wall and the second lower retaining wall are disposed corresponding to each other.
